(19) United States
(12) Patent Application Publication
(10) Pub. No.: US 2020/0320835 A1
(43) Pub. Date: Oct. 8, 2020

(54) A DEVICE FOR RENDERING HAPTIC FEEDBACK TO A USER AND A METHOD FOR OPERATING THE DEVICE

(71) Applicant: KONINKLIJKE PHILIPS N.V., EINDHOVEN (NL)

(72) Inventors: Matthew John LAWRENSON, Bussigny-pres-de-lausanne (CH); Vincentius Paulus BUIL, Veldhoven (NL); Lucas Jacobus Franciscus GEURTS, Best (NL)

(21) Appl. No.: 16/305,185

(22) PCT Filed: Jun. 2, 2017
(86) PCT No.: PCT/EP2017/063550

§ 371 Date: Nov. 28, 2018

(30) Foreign Application Priority Data
Jun. 7, 2016 (EP) 16173413.2

(51) Int. Cl. G08B 6/00

(52) U.S. Cl. CPC G08B 6/00

(57) ABSTRACT

There is provided a device for rendering haptic feedback to a user and method for operating the device to render the haptic feedback to the user of the device. The device comprises a first part operable to apply a non-invasive action on a part of the body of the user and a second part operable to be held by the user and to render haptic feedback to the user. At least one sensor signal indicative of an interaction between the first part of the device and the 5 part of the body of the user is acquired (402). The acquired at least one sensor signal is processed to determine haptic feedback representative of the interaction between the first part of the device and the part of the body of the user (404). The determined haptic feedback is rendered to the user at the second part of the device (406).

### FIELD OF THE INVENTION

The invention relates to a device for rendering haptic feedback to a user and a method for operating the device to render the haptic feedback.

### BACKGROUND OF THE INVENTION

A user operating a device can often lose focus or concentration on the activity they are performing with the device. Certain activities performed with a device operated by a user can become tedious or uninteresting. This is particularly the case when those activities are to be performed by the user routinely or often. For example, personal care activities (such as shaving, skin cleansing, brushing teeth, flossing teeth, or similar) can be mundane tasks. Also, many health care devices need to be used frequently by a user and the user can lose interest in using those devices. This can be problematic, particularly when the user is intended to acquire health-related data for monitoring purposes by using those devices.

Increased focus and concentration during activities such as those mentioned can be achieved with practice over a period of time. However, this relies on the user having the willpower to practice and improve their focus and concentration. There exist methods that aid the user in maintaining focus and concentration by manual intervention, such as alarms. However, these manual interventions are easy to ignore.

One reason that routine activities can be mundane is that there is no feedback provided to the user and the devices are not interactive. Without feedback or interaction, the user may feel that they are making no progress and may be anxious that they are not performing an activity correctly. There exist tools with which the user can practice on virtual models in order to train themselves to perform certain tasks.

For example, US 2010/0015589 A1 discloses a toothbrush that is physically connected to a force-feedback haptic device for training purposes. The haptic device provides feedback consisting of forces, vibration and/or motions that mimic those associated with brushing teeth on a virtual model. However, this form of training is time consuming and the user still has no information on the progress, efficacy or completeness of their efforts in daily life.

It is to be noted that WO 2014/036423 A1 discloses a toothbrush training system for children in which the toothbrush comprises a haptic feedback unit configured to vibrate. In this patent document it is state that haptic feedback has been found to be useful for providing feedback for deviation from the desired angle of attack. The amplitude of the vibration may increase to indicate increasing deviation. Therefore, there is a need for an improved method to increase the focus of a user on certain activities that require use of a device and enhance the activities with feedback to provide better results from those activities.

### SUMMARY OF THE INVENTION

As noted above, a limitation with existing devices is that the user is unaware of the progress, efficacy and completeness of tasks they perform with a device, which reduces the focus of the user in performing those tasks.

It is desirable for a user to be aware that the mundane tasks performed with devices are having a positive effect. At the same time, it is useful for a user to be made aware of ways in which they can improve their performance in real-time to achieve better results. In particular, it would be helpful for a user to be notified during an activity in which they use a device of the potential consequences or outcomes of their actions in order for the user to adapt their use of the device. For example, it is useful for the user to be aware of remaining hairs or razor burn when using a shaving device, remaining impurities or skin irregularities when using a skin care device, remaining plaque or over-brushing of gums when using a toothbrush, or similar.

Therefore, according to a first aspect of the invention, there is provided a method for operating a device to render haptic feedback to a user of the device, the device comprising a first part operable to apply a non-invasive action on a part of the body of the user and a second part operable to be held by the user and to render haptic feedback to the user. The method comprises acquiring at least one sensor signal indicative of an interaction between the first part of the device and the part of the body of the user, processing the acquired at least one sensor signal to determine haptic feedback representative of the interaction between the first part of the device and the part of the body of the user, and rendering the determined haptic feedback to the user at the second part of the device.

The acquired at least one sensor signal indicative of an interaction between the first part of the device and the part of the body of the user may be indicative of one or more of: a surface structure of the part of the body of the user and a property of the part of the body of the user.

In some embodiments, the acquired at least one sensor signal indicative of an interaction between the first part of the device and the part of the body of the user may be indicative of a speed with which the first part of the device moves on the part of the body of the user.

In some embodiments, the acquired at least one sensor signal indicative of an interaction between the first part of the device and the part of the body of the user may be indicative of a direction in which the first part of the device moves on the part of the body of the user.

In some embodiments, the method may further comprise sensing at least one area of the second part of the device that is held by the user.

In some embodiments, rendering the determined haptic feedback to the user using the second part of the device may comprise rendering the determined haptic feedback to the user using at least part of one or more of the sensed at least one areas of the second part of the device held by the user.

In some embodiments, the method may further comprise determining which of the sensed at least one areas of the second part of the device held by the user is the least distance from the first part of the device.

In some embodiments, rendering the determined haptic feedback to the user using the second part of the device may comprise rendering the determined haptic feedback to the user using at least part of one or more of the sensed at least one areas of the second part of the device held by the user that is determined to be the least distance from the first part of the device.

In some embodiments, the method may further comprise one or more of: modifying the determined haptic feedback over time, and modifying the determined haptic feedback in accordance with the acquired at least one sensor signal.

In some embodiments, the method may further comprise determining an effect of the interaction between the first part of the device and the part of the body of the user based on the acquired at least one sensor signal, wherein processing the acquired at least one sensor signal to determine haptic feedback representative of the interaction between the first part of the device and the part of the body of the user may comprise processing the acquired at least one sensor signal to determine haptic feedback representative of the determined effect of the interaction between the first part of the device and the part of the body of the user.

According to a second aspect of the invention, there is provided a computer program product comprising a computer readable medium, the computer readable medium having computer readable code embodied therein, the computer readable code being configured such that, on execution by a suitable computer or processor, the computer or processor is caused to perform the method or the methods described above.

According to a third aspect of the invention, there is provided a device for rendering haptic feedback to a user, the device comprising a first part operable to apply a non-invasive action on a part of the body of the user, a second part operable to be held by the user, and a control unit. The control unit is configured to acquire at least one sensor signal indicative of an interaction between the first part of the device and the part of the body of the user, and process the acquired at least one sensor signal to determine haptic feedback representative of the interaction between the first part of the device and the part of the body of the user. The acquired at least one sensor signal being indicative of one or more of: a surface structure of the part of the body of the user and a property of the part of the body of the user The second part comprises at least one haptic feedback component configured to render the determined haptic feedback to the user.

In some embodiments, the first part of the device may comprise one or more first sensors and the control unit may be configured to control the one or more first sensors to acquire the at least one sensor signal.

In some embodiments, the haptic feedback component may comprise one or more of a component configured to: change temperature, vibrate, change a plane of a surface, change a pressure, provide electric stimulation, provide ultrasound, release air or liquid, and change texture.

In some embodiments, the device may be a tooth care device, a skin care device, a grooming device, a hair care device, a massage device, or a skin health device.

According to the above aspects, the focus of the user during a task performed using a device is increased by way of the haptic feedback that directly correlates with their actions. Also, the user can improve the results achieved through performing the task by way of the haptic feedback that directly represents the real-time interaction of the device on the body of the user. In this way, the user can be provided with information on the progress, efficacy and completeness of their actions, which in turn increases their motivation to perform the task.

There is thus provided an improved device and method that increases the focus of a user using the device and enables the user to improve their performance in tasks using the device.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of a device according to an embodiment;

FIG. 2 is a flow chart illustrating a method according to an embodiment;

FIG. 3 is a flow chart illustrating a method according to another embodiment;

FIG. 4 is a flow chart illustrating a method according to another embodiment; and

FIG. 5 is a flow chart illustrating a method according to an exemplary embodiment.

### DETAILED DESCRIPTION OF THE EMBODIMENTS

As noted above, the invention provides an improved device and method for providing haptic feedback, which overcomes the existing problems.

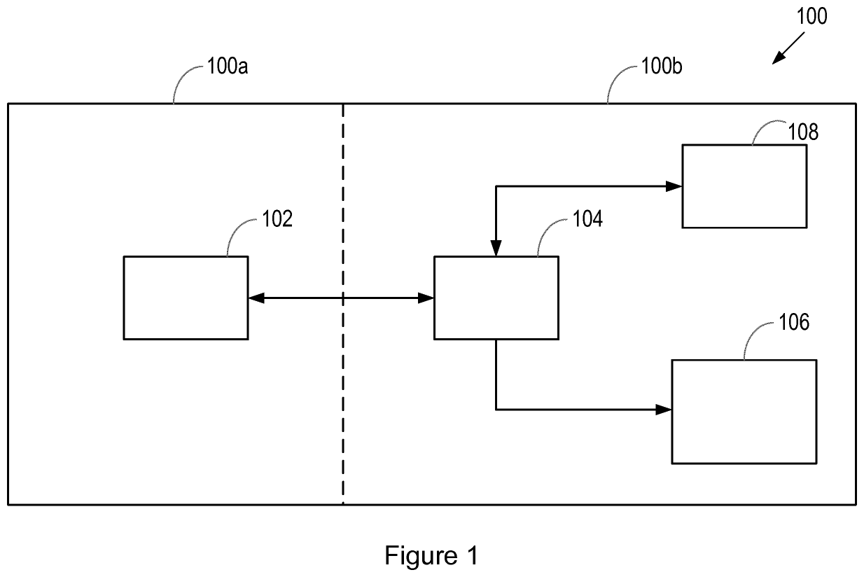

FIG. 1 shows a block diagram of a device 100 according to an embodiment of the invention that can be used for providing haptic feedback (for example, tactile feedback) to a user of the device 100. The device 100 comprises a first part 100a operable to apply a non-invasive action on a part of the body (such as the skin, teeth, hair, or similar) of the user and a second part 100b operable to be held by the user. The first part 100a of the device 100 is, for example, a utility end of the device 100. The second part 100b of the device 100 is, for example, a handle of the device 100.

It will be understood that the term “non-invasive action” used herein is any action that does not penetrate the body of the user by surgical insertion, incision, or injection. Examples of a non-invasive action include cleaning teeth, flossing teeth, cleansing skin, removing hair (such as shaving), massaging, hair straightening, or similar. Although examples of non-invasive actions have been provided, other non-invasive actions will be appreciated.

The device 100 can be any type of device operable to apply a non-invasive action on the body of a user. For example, the device may be a personal care device or a health care device. Examples of a personal care device include a tooth care device (for example, a toothbrush, a flosser, tongue cleaner, or similar), a skin care device (for example, a cleansing device, a microdermabrasion device, an Intense Pulsed Light (IPL) device, or similar), a grooming device (for example, a hair trimmer, a hair removal device such as a shaving device or an epilator, or similar), a hair care device (for example, straighteners, curlers, a styling tool, or similar), or any other personal care device. Examples of a health care device include a massage device, a skin health device, or any other health care device. A skin health device may be a device configured to sense skin properties such as blood vessels, lymph vessels or nodes, fat tissue, or other skin properties. In one example, a skin health device may comprise a camera operable to be held against or to hold onto the skin of the user to assess skin issues. Although examples of the type of device have been provided, it will be understood that the device 100 may be any other type of device that is operable to apply a non-invasive action on the body of a user.

In the illustrated embodiment of FIG. 1, the first part 100a of the device 100 comprises one or more first sensors 102. The one or more first sensors 102 can be configured to acquire at least one sensor signal indicative of an interaction between the first part 100a of the device 100 and a part of the body of a user. Although the first part 100a of the device 100 comprises one or more first sensors 102 in this illustrated embodiment, it will be understood that the one or more first sensors 102 or at least one of the one or more first sensors 102 can be external to (i.e. separate to or remote from) the device 100.

The one or more first sensors 102 may be any sensor or combination of sensors suitable to sense an interaction between the first part 100a of the device 100 and the part of the body of the user. Examples of such a sensor include a visual or image sensor (for example, a camera, a video, an infra-red sensor, a multispectral image sensor, a hyperspectral image sensor, or any other visual sensor), an acoustic sensor (for example, a microphone or any other acoustic sensor), a motion or inertial sensor (for example, an accelerometer, a gyroscope such as an inertial gyroscope or a microelectromechanical MEMS gyroscope, a magnetometer, a visual sensor, or any other motion sensor), a pressure sensor, a temperature sensor, a moisture sensor, or similar. A motion or inertial sensor is a sensor operable to detect the motion of the device 100 relative to the user and optionally also the orientation of the device 100. It will be understood that the one or more first sensors 102 can comprise a single sensor or more than one sensor and that the more than one sensor may comprise one type of sensor or any combination of different types of sensor. For example, in a tooth care embodiment, one sensor may detect a tooth and another sensor (such as an inertial or motion sensor) may sense the number of times that tooth is brushed. In a grooming embodiment, a single sensor (such as a camera) may detect a shaving motion.

Although examples have been provided for the one more first sensor 102, it will be understood that other sensors or combination of sensors suitable to sense at least one area of the second part 100b of the device 100 that is held by the user.

In the illustrated embodiment, the second part 100b of the device 100 comprises a control unit 104 that controls the operation of the device 100 and that can implement the method describe herein. The control unit 104 can comprise one or more processors, processing units, multi-core processors or modules that are configured or programmed to control the device 100 in the manner described herein. In particular implementations, the control unit 104 can comprise a plurality of software and/or hardware modules that are each configured to perform, or are for performing, individual or multiple steps of the method according to embodiments of the invention. Although the second part 100b of the device 100 comprises the control unit 104 in this illustrated embodiment, it will be understood that the first part 100a of the device 100 may instead comprise the control unit 104 or the control unit 104 may be located at the interface between the first part 100a and second part 100b of the device 100.

Briefly, the control unit 104 is configured to acquire at least one sensor signal indicative of an interaction between the first part of the device and the part of the body of the user and process the acquired at least one sensor signal to determine haptic feedback representative of the interaction between the first part of the device and the part of the body of the user. In some embodiments, the control unit 104 may be configured to control the one or more first sensors 102 to acquire the at least one sensor signal.

In the embodiment where the one or more first sensors 102, or at least one of the one or more first sensors 102, are external to (i.e. separate to or remote from) the device 100, the control unit 104 may communicate with the external first sensors 102 wirelessly or via a wired connection. For example, the control unit 104 may be configured to control the external first sensors 102 to acquire the at least one sensor signal wirelessly or via a wired connection.

In the illustrated embodiment, the second part 100b of the device 100 also comprises at least one haptic feedback component 106. For example, the haptic feedback component 106 can form a portion or part of the surface of the second part 100b of the device 100 that is held by the user. The haptic feedback component 106 is configured to render the determined haptic feedback to the user in response to a signal from the control unit 104. In other words, the haptic feedback component 106 can deliver a haptic sensation to the user.

The haptic feedback component 106 can be any component suitable to provide haptic feedback to a user. Examples of a haptic feedback component 106 include a component configured to change temperature (for example, a Peltier component, or any other thermal stimulation component), vibrate (for example, a vibrotactile component, or similar), change a plane of a surface (for example, a component suitable to raise or lower at least a portion of a surface, a spatially and/or temporally variable component, an electro-vibration based friction display component), change a pressure (for example, a piezoelectric, dielectric elastomer or electroactive component changing a surface tension), provide electric stimulation (for example, an AC or DC voltage release via galvanic contacts), provide ultrasound (for example, piezoelectric, dielectric elastomer or electroactive components), release air or a liquid such as water (for example, a pneumatic component, or a piezoelectric, dielectric elastomer or electroactive component driving a valve and compression chamber), change texture (for example, using a vibrotactile component, a piezoelectric component, an electromagnetic component, a pneumatic component, an electroactive component, or similar). Although examples have been provided for a haptic feedback component, it will be appreciated that other haptic feedback components or any combination of haptic feedback components can be used.

Returning to the illustrate embodiment of FIG. 1, the second part 100b of the device 100 also comprises one or more second sensors 108 in the illustrated embodiment. The one or more second sensors 108 are configured to sense at least one area of the second part 100b of the device 100 that is held by the user. In some embodiments, the control unit 104 can be configured to control the one or more second sensors 108 to sense at least one area of the second part 100b of the device 100 that is held by the user. The one or more second sensors 108 may be any sensor or combination of sensors suitable to sense at least one area of the second part 100b of the device 100 that is held by the user. Examples of such a sensor include a visual or image sensor (such as a camera, a video, an infra-red sensor, a multispectral image sensor, a hyperspectral image sensor, or any other visual sensor), an acoustic sensor (such as a microphone or any other acoustic sensor), a pressure sensor, a temperature sensor, a moisture sensor, or any other sensor or combination of sensors suitable to sense at least one area of the second part 100b of the device 100 that is held by the user. In some embodiments, the one or more second sensors 108 may be in the form of an array (for example, a matrix) of sensors such as an array of pressure or touch sensors.

Although the second part 100b of the device 100 is shown to comprise one or more second sensors 108 and a separate haptic feedback component 106 in this illustrated embodiment, it will be understood that the haptic feedback component 106 may itself comprise the one or more second sensors 108 in other embodiments.

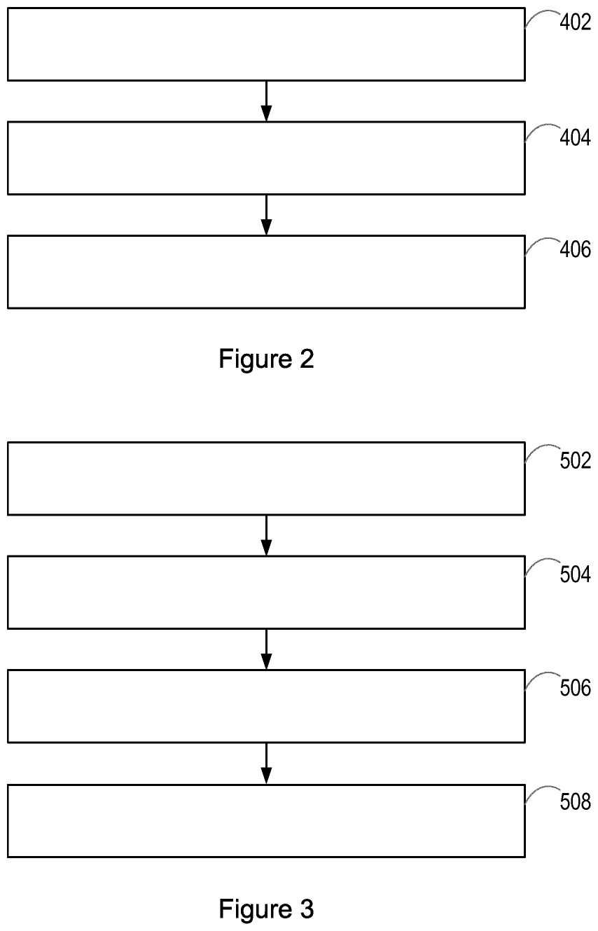

FIG. 2 is a flow chart illustrating a method for operating the device 100 to render haptic feedback (for example, tactile feedback) to a user of the device 100 according to an embodiment. The illustrated method can generally be performed by or under the control of the control unit 104 of the device 100.

With reference to FIG. 2, at block 402, at least one sensor signal indicative of an interaction between the first part 100a of the device 100 and the part of the body of the user is acquired. For example, one or more first sensors 102 may acquire at least one sensor signal indicative of an interaction between the first part 100a of the device 100 and a part of the body of a user. As described earlier, the control unit 104 may be configured to control the one or more first sensors 102 to acquire the at least one sensor signal. In some embodiments, at least one sensor signal indicative of an interaction between the first part 100a of the device 100 and the part of the body of the user may be acquired during use of a sensing aid such as a light source illumination of a set wavelength, plaque disclosing tablets, or any other sensing aid.

In effect, the one or more first sensors 102 are capable of sensing a non-invasive action applied by the first part 100a of the device 100. For example, the one or more first sensors 102 may be capable of sensing a non-invasive action such as brushing a certain area of the mouth or gums, shaving a particular area, shaving a particular type or length of hair, or any other non-invasive or combination of non-invasive actions. In addition, the one or more first sensors 102 can be capable of providing information about the non-invasive action. For example, the one or more first sensors 102 may be capable of providing information such as the density of the hair being shaved, the amount of plaque on a tooth, or any other information about the event.

In some embodiments, the acquired at least one sensor signal indicative of an interaction between the first part 100a of the device 100 and the part of the body of the user is indicative of a surface structure of the part of the body of the user. As previously mentioned, examples of a surface structure of the part of the body of the user may be the surface structure of the teeth, hair, skin or any other part of the body of the user.

In some embodiments, the acquired at least one sensor signal indicative of an interaction between the first part 100a of the device 100 and the part of the body of the user is indicative of a property of the part of the body of the user. Examples of a property of the part of the body of the user are a skin property (such as a moisture level, cleanliness, irritation, or similar during use of a skin care device), a tooth property (such as the amount of plaque on a tooth during use of a tooth care device), a muscle property (such as muscle tension), a hair property (such as temperature, moisture, or similar of the hair during use of a hair care device), a grooming property (such as the density, length, or similar of facial hair during use of a grooming device), or similar. Although examples have been provided for the property of the part of the body of the user, it will be understood that the property may be any property of any part of the body of the user.

In some embodiments, the acquired at least one sensor signal indicative of an interaction between the first part 100a of the device 100 and the part of the body of the user is indicative of a speed with which the first part 100a of the device 100 moves on the part of the body of the user. In some embodiments, the acquired at least one sensor signal indicative of an interaction between the first part 100a of the device 100 and the part of the body of the user is indicative of a direction in which the first part 100a of the device 100 moves on the part of the body of the user. In some embodiments, the acquired at least one sensor signal indicative of an interaction between the first part 100a of the device 100 and the part of the body of the user is indicative of the movement speed and direction in which the first part 100a of the device 100 moves on the part of the body of the user.

In some embodiments, the acquired at least one sensor signal indicative of an interaction between the first part 100a of the device 100 and the part of the body of the user is indicative of any combination of a surface structure of the part of the body of the user, a property of the part of the body of the user, a speed with which the first part 100a of the device 100 moves on the part of the body of the user, and direction in which the first part 100a of the device 100 moves on the part of the body of the user. Although examples have been provide for the at least one sensor signal, it will be understood that the acquired at least one sensor signal may be indicative of any other interaction between the first part 100a of the device 100 and the part of the body of the user or any combination of interactions between the first part 100a of the device 100 and the part of the body of the use.

At block 404, the acquired at least one sensor signal is processed to determine haptic feedback representative of the interaction between the first part 100a of the device 100 and the part of the body of the user. In other words, the acquired at least one sensor signal is processed to determine a haptic sensation that when rendered to the user will provide the user with feedback on the non-invasive action that is being applied by the first part 100a of the device 100.

In some embodiments, the haptic feedback may be determined by comparing the at least one sensor signal to a database of stored sensor signals that are characteristic of certain actions or events. For example, the stored sensor signals can comprise a sequence of sensor data that can provide an indication that a certain event or action is taking place if identified as being present in the at least one sensor signal. In exemplary embodiments, the stored sensor signals can comprise signals characteristic of a razor across the skin, a toothbrush brushing teeth, or similar. The database of sensor signals may be in the form of a look-up table or similar. The device 100 may comprise the database or the database may be external to (i.e. separate or remote) from the device 100. The control unit 104 may access the database to compare the at least one sensor signal to stored sensor signals wirelessly or via a wired connection.

In some embodiments, the determined haptic feedback can have an associated variable component used to vary the determined haptic feedback as the first part 100a of the device 100 is moved over the part of the body of the user to convey information to the user. For example, the determined haptic feedback may have an amplitude set to convey information to the user. Specifically, the amplitude of the determined haptic feedback can be proportional to a property of the part of the body of the user with which the first part 100a of the device 100 is interacting. For example, in a grooming embodiment, the determined haptic feedback may be varied depending on the length of hair being shaved. Here, an increase in the amplitude of the determined haptic feedback can represent an increase in the length of hair being shaved and, similarly, a decrease in the amplitude of the determined haptic feedback can represent a decrease in the length of hair being shaved. In a tooth care embodiment, combined information of toothbrush movement and location may be used to determine a measure for cleanness and the determined measure for cleanness can be translated via a conversion function to be represented in the determined haptic feedback, which can motivate better brushing. In some embodiments, the determined haptic feedback can be varied to provide a sensation of roughness as the first part 100a of the device 100 is moved over an area of rough skin, plaque, or the like.

In some embodiments, the acquired at least one sensor signal is mapped to a haptic sensation directly. In other words, the determined haptic feedback may directly represent the interaction between the first part 100a of the device 100 and the part of the body of the user. For example, a bump that occurs to the first part 100a of the device 100 during the non-invasive action will be represented by a bump of equal magnitude and duration in the determined haptic feedback.

In other embodiments, the acquired at least one sensor signal may be mapped to a haptic sensation representative of a sensation at the part of the body with which the first part 100a of the device 100 is interacting that has not yet occurred. In other words, a sensation at the part of the body can be predicted. Specifically, the determined haptic feedback may represent a sensation that will result from or that is associated with the interaction between the first part 100a of the device 100 and the part of the body of the user. For example, a razor burn associated with shaving may occur when a shaver is applied over the same area of skin too often and/or with too much pressure and this action can be used to predict razor burn, which may then be represented by an increase in heat in the haptic feedback even before the razor burn actually occurs. The signal providing the haptic feedback in the form of heat can be amplified to provide an early warning to the user to prevent (or at least reduce the amount of) razor burn. The user may set a preference for the sensitivity for the amplification. In this way, the determined haptic feedback represents a sensation resulting from or associated with the interaction before the sensation occurs such that the user can adapt their use of the device 100 to avoid a negative result (such as skin irritation, razor burn, gum irritation, or similar).

In embodiments where the acquired at least one sensor signal indicative of a surface structure of the part of the body of the user, the determined haptic feedback is representative of the surface structure of the part of the body of the user. For example, a raised portion in the surface structure will be represented by a raised portion in the determined haptic feedback. In embodiments where the acquired at least one sensor signal indicative of a property of the part of the body of the user, the determined haptic feedback is representative of the property of the part of the body of the user. In embodiments where the acquired at least one sensor signal indicative of a speed with which the first part 100a of the device 100 moves on the part of the body of the user, the determined haptic feedback is representative of the speed with which the first part 100a of the device 100 moves on the part of the body of the user. For example, the first part 100a of the device 100 moving in at a certain speed will be represented by a movement of the same speed in the determined haptic feedback. In embodiments where the acquired at least one sensor signal indicative of a direction in which the first part 100a of the device 100 moves on the part of the body of the user, the determined haptic feedback is representative of direction in which the first part 100a of the device 100 moves on the part of the body of the user. For example, the first part 100a of the device 100 moving in a certain direction will be represented by a movement in the determined haptic feedback in the same direction.

In embodiments where the acquired at least one sensor signal indicative of more than one interaction between the first part 100a of the device 100 and the part of the body of the user, the determined haptic feedback can be representative of one or more of those interactions between the first part 100a of the device 100 and the part of the body of the user. For example, in some embodiments, the determined haptic feedback can be representative of the surface structure of the part of the body of the user and the movement (such as one or more of the speed and direction) of the first part 100a of the device 100 on the part of the body of the user.

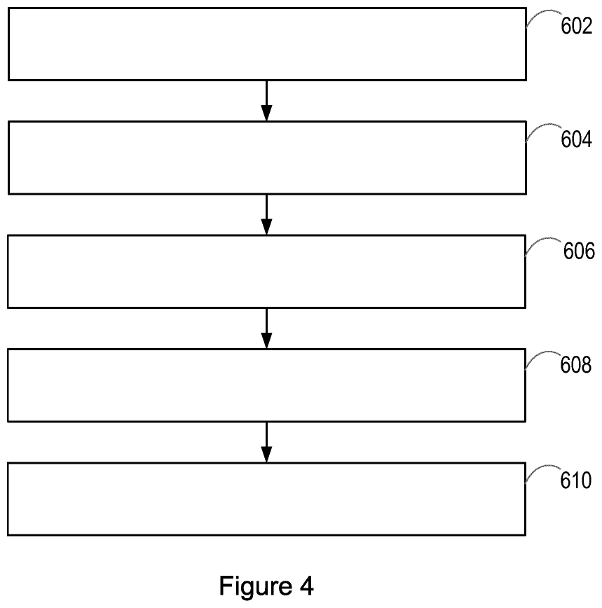

Returning again to FIG. 4, at block 406, the determined haptic feedback is rendered to the user at the second part 100b of the device 100. In some embodiments, the rendered haptic feedback can provide the user with a sense that the part of the body on which the first part 100a of the device 100 is moving (or applying a non-invasive action) is virtually moving underneath the part of their hand holding the second part 100b of the device 100. The location at which the determined haptic feedback is rendered may be any one or more fixed locations, which may be freely selectable, or may be determined dynamically by sensing the areas of the second part 100b of the device 100 that the user is holding (which will be explained in more detailed with reference to the embodiments illustrated in FIGS. 3 and 4).

FIG. 3 is a flow chart illustrating a method for operating the device 100 to render haptic feedback to a user of the device 100 according to another embodiment. The illustrated method can generally be performed by or under the control of the control unit 104 of the device 100.

With reference to FIG. 3, at block 502, at least one sensor signal indicative of an interaction between the first part 100a of the device 100 and the part of the body of the user is acquired and, at block 504, the acquired at least one sensor signal is processed to determine haptic feedback representative of the interaction between the first part 100a of the device 100 and the part of the body of the user. In other words, the method described above with reference to block 402 and block 404 of FIG. 2 is performed, which will not be repeated here but will be understood to apply.

Then, at block 506 of FIG. 3, at least one area of the second part 100b of the device 100 that is held by the user is sensed. For example, the one or more second sensors 108 may sense at least one area of the second part 100b of the device 100 that is held by the user. In other words, the one or more second sensors 108 may sense at least one area of the second part 100b of the device 100 that the user is touching. For example, the one or more second sensors 108 can include at least one touch sensor (such as those used in touchscreens) that is capable of determining where a surface is being touched. As described earlier, the control unit 104 can be configured to control the one or more second sensors 108 to sense at least one area of the second part 100b of the device 100 that is held by the user.

At block 508, the determined haptic feedback is rendered to the user using at least part of one or more of the sensed at least one areas of the second part 100b of the device 100 held by the user. In some embodiments, the rendered haptic feedback can provide the user with a sense that the part of the body on which the first part 100a of the device 100 is moving (or applying a non-invasive action) is virtually moving underneath the part of their hand that is holding the second part 100b of the device 100 where the determined haptic feedback is rendered.

FIG. 4 is a flow chart illustrating a method for operating the device 100 to render haptic feedback to a user of the device 100 according to another embodiment. The illustrated method can generally be performed by or under the control of the control unit 104 of the device 100.

With reference to FIG. 4, at block 602, at least one sensor signal indicative of an interaction between the first part 100a of the device 100 and the part of the body of the user is acquired and, at block 604, the acquired at least one sensor signal is processed to determine haptic feedback representative of the interaction between the first part 100a of the device 100 and the part of the body of the user. In other words, the method described above with reference to block 402 and block 404 of FIG. 2 is performed, which will not be repeated here but will be understood to apply.

Then, at block 606 of FIG. 4, at least one area of the second part 100b of the device 100 that is held by the user is sensed. For example, the one or more second sensors 108 may sense at least one area of the second part 100b of the device 100 that is held by the user. As described earlier, the control unit 104 can be configured to control the one or more second sensors 108 to sense at least one area of the second part 100b of the device 100 that is held by the user.

At block 608, it is determined which of the sensed at least one areas of the second part 100b of the device 100 held by the user is the least distance from (i.e. the closest to) the first part 100a of the device 100. In other words, the position of the hand of the user on the second part 100b of the device is identified and it is determined which part of the hand is closest to the area the non-invasive action is being applied. In some embodiments, the determination of which part of the hand is closest to the area the non-invasive action is being applied may take into account a determined manner in which the device 100 is being moved. In a tooth care embodiment, the part of the hand closest to the area to which the non-invasive action is applied may be the part of the hand closest to a brush head of a toothbrush or closest to an area of a tooth being cleaned. In a grooming embodiment, the part of the hand closest to the area to which the non-invasive action is applied this be the part of the hand closest to a shaving blade or closest to an area of a cheek being shaved.

Then, at block 610, the determined haptic feedback is rendered to the user using at least part of one or more of the sensed at least one areas of the second part 100b of the device 100 held by the user that is determined to be the least distance from (i.e. the closest to) the first part 100a of the device 100. In some embodiments, the rendered haptic feedback can provide the user with a sense that the part of the body on which the first part 100a of the device 100 is moving (or applying a non-invasive action) is virtually moving underneath the part of their hand that is holding the second part 100b of the device 100 where the determined haptic feedback is rendered.

In the embodiments in which at least one area of second part 100b of the device 100 that is held by user is sensed (at block 506 of FIG. 3 and at block 606 of FIG. 4), the method may further comprise sensing whether the at least one area of second part 100b of the device 100 that is held by user has changed. For example, it may be sensed whether the position of a hand of the user has moved on the second part 100b of the device 100. If it is sensed that the at least one area of second part 100b of the device 100 that is held by user has changed, the at least one area is updated and the determined haptic feedback is rendered to the user at one or more of the updated at least one areas.

In some embodiments, the part of the body of the user (for example, hand, fingers, or the like) that is holding the second part 100b of the device 100 may be determined. For example, it may be determined which part of the hand (such as which part of the palm of the hand) of user is holding the second part 100b of the device 100, or which fingers (or part of the fingers) of the hand of the user are holding the second part 100b of the device 100. This may involve a comparison of a signal acquired from the one or more second sensors 108 of the device indicative of the user holding the second part 100b of the device 100 with at least one model (or template) of a part of the body stored in a database. For example, the model may be a model of a hand of the user and may include information relating to the hand. The model may be a generic model or may be specific to the user themselves. In some embodiments, the database may store at least one model of an adult hand and at least one model of an infant hand. In these embodiments, it may be determined through a comparison of the signal acquired from the one or more second sensors 108 of the device indicative of the hand of the user holding the second part 100b of the device 100 and the models stored in the database whether the user is an adult or an infant. In some embodiments, it may be determined through a comparison of the signal acquired from the one or more second sensors 108 of the device indicative of the hand of the user holding the second part 100b of the device 100 and at least one model in a database whether the left hand or right hand of the user is holding the second part 100b of the device 100.

Alternatively or in addition to comparison with at least one model stored in a database, determining which part of the hand of user is holding the second part 100b of the device 100 may be based on a signal acquired from an image sensor (such as a camera). The image sensor may be one or more of the first sensors 102 or may be an external sensor that is capable of acquiring an image of the second part 100b of the device 100 that is held by the user. Alternatively or in addition, determining which part of the hand of the user is holding the second part 100b of the device 100 may comprise a biometric measurement (such as a measure of one or more fingerprints, one or more capillary locations, or any other biometric measurement) that can be used to determine the part of the hand holding the second part 100b of the device 100.

In the embodiment where the part of the body of the user holding the second part 100b of the device 100 is determined, the determined haptic feedback may be adjusted based on a sensitivity of the part of the body of the user determined to be holding the second part 100b of the device 100. In other words, the determined haptic feedback may be adjusted based on the ability of the skin on that part of the body to resolve sensations. For example, the fingertips have greater ability to resolve sensations than other parts of the hands. Therefore, in one embodiment, the strength or spatial resolution of determined haptic feedback may be adjusted to account for whether the fingertips are used. Alternatively or in addition, in some embodiments, a location at which to render the haptic feedback is determined based on the determined part (or parts) of the body of the user with which the user is holding the second part 100b of the device 100.

In some embodiments, it may be sensed that the part of the body of the user holding the second part 100b of the device 100 (for example, the hand or fingers of the user) is moving and the sensed movement may be used to modify the determined haptic feedback. For example, if the determined haptic feedback involves motion, the motion of the haptic feedback rendered may be reduced or increased in dependence on the motion of the part of the body holding the second part 100b of the device 100.

In some embodiments, it is determined which area of the part of the body of the user holding the second part 100b of the device 100 (for example, the hand or fingers of the user) the user is likely to use to practice performing the non-invasive action with the part of the body itself. In this embodiment, the haptic feedback is rendered to that determined area. For example, it may be determined which area of a finger in contact with the second part 100b of the device 100 the user is likely to use if they were to practice shaving their face with their finger and the haptic feedback is then rendered to that determined area of their finger.

In any of the embodiments illustrated in FIGS. 2, 3 and 4, the determined haptic feedback may be modified over time and, alternatively or in addition, the determined haptic feedback may be modified in accordance with the acquired at least one sensor signal. In other words, the determined haptic feedback component 108 may be a variable haptic feedback component 108 that can be modified over time and, alternatively or in addition, in accordance with the acquired at least one sensor signal. In this way, the user can be provided with feedback (such as the progress, efficacy and/or completeness) of their actions in using the device 100.

For example, in a tooth care embodiment, the roughness of the texture provided by the haptic feedback component 106 can be reduced as the tooth is cleaned for a period of time or the temperature of the haptic feedback component 106 can be increased if a gum is brushed more than a threshold number of times. In another tooth care embodiment, the amplitude of the haptic feedback can be associated with the number of times a toothbrush is moved over a predefined area or at least one predefined tooth and/or the time spent brushing the predefined area or the at least one predefined tooth. For example, the amplitude of the haptic feedback may be decreased each time the toothbrush is detected (for example, via one or more motion sensors) to move over the predefined area or the at least one predefined tooth and/or the longer the period of time the predefined area or the at least one predefined tooth is brushed. The amplitude of the haptic feedback may be decreased to zero after a set number of passes over the predefined area or the at least one predefined tooth (for example, after two passes, three passes, four passes, or any other set number) or after a set period of time the predefined area or the at least one predefined tooth is brushed. In another tooth care embodiment, a predefined area or at least one predefined tooth may require more attention. In this embodiment, the number of passes over and/or the period of time spent brushing this predefined area or this at least one predefined tooth may be set to a higher value. This information (which may be provided via a user input) can be represented in the haptic feedback. In a grooming embodiment, the amplitude of the haptic feedback provided by the haptic feedback component 106 can be reduced as an area of face is shaved multiple times. In this way, the user is provided with feedback as an action is performed using the device 100.

In any of the embodiments illustrated in FIGS. 2, 3 and 4, the method may further comprise determining an effect of the interaction between the first part 100a of the device 100 and the part of the body of the user based on the acquired at least one sensor signal. Then, processing the acquired at least one sensor signal to determine haptic feedback representative of the interaction between the first part 100a of the device 100 and the part of the body of the user comprises processing the acquired at least one sensor signal to determine haptic feedback representative of the determined effect of the interaction between the first part 100a of the device 100 and the part of the body of the user.

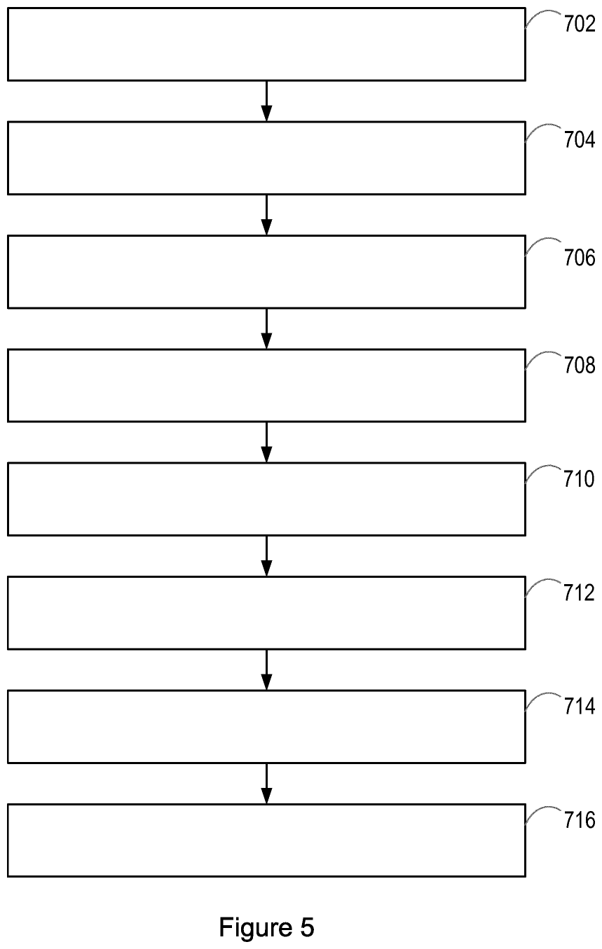

FIG. 5 is a flow chart illustrating a method for operating the device 100 to render haptic feedback to a user of the device 100 according to an exemplary embodiment. The illustrated method can generally be performed by or under the control of the control unit 104 of the device 100.

With reference to FIG. 5, at block 702, the action of the user picking up the device 100 is detected and the action for which the device will be used is determined. In one embodiment, the action for which the device will be used may be determined based on the fact that the device is a single use device. For example, the device may be a toothbrush with a single setting. In another embodiment, the action for which the device will be used may be determined based on a user input. For example, the device 100 may be a multi-use device (such as a shaver operable to perform multiple shaving tasks) and the user input may be a selection of a particular setting on the device. In another embodiment, the action for which the device will be used may be determined based on data acquired from the one or more first sensors 102, the one or more second sensors 108, or any combination of these sensors.

At block 704, the characteristics of events associated with the determined action are determined. For example, the characteristics may be acquired from a database where the characteristics are stored with associated haptic sensations and any variable components for those haptic sensations.

At block 706, the one or more first sensors 102 continuously monitor the use of the device 100 and the signals acquired from the one or more first sensors 102 are analysed to detect occurrence of any of the events associated with the determined action (for example, by determined whether the characteristics are present in the acquired signals). Any additional sensor information required to apply any associated variable component of the associated haptic signal is also collected. The collected information can be stored for a pre-determined period of time (such as a period of time long enough to be used to render haptic feedback) and then deleted once it is no longer needed. Optionally, data concerning the motion and other mechanical variables (such as pressure) of the device 100 at the time of the may be gathered and stored. As before the data may only be stored for the pre-determined period of time.

At block 708, it is determined that an event associated with the determined action is occurring. Also, the haptic sensation associated with the event and any variable components for those haptic sensations are identified and acquired (for example, from the database). The haptic feedback is determined on this basis. At block 710, the determined haptic feedback is combined with the additional sensor information acquired to apply any associated variable component and a configuration for the determined haptic feedback is set on this basis. At block 712, it is determined which part of the device 100 is held by the user and, at block 714, an area of that part of the device 100 at which to apply the determined haptic feedback is selected.

At block 716, the determined haptic feedback is rendered (or provided) at the selected area. For example, the haptic feedback is be applied to at least part of the hands of the user that are in contact with the device 100.

There is therefore provided an improved device and method that increases the focus of a user using the device and enables the user to improve their performance in tasks performed with the device. This can be useful for any handheld device for which haptic feedback can provide sensations to a user that are otherwise lost due to the user holding a static body of the device. Examples include personal care devices and health care devices such as those mentioned earlier.

According to an exemplary embodiment a skin care device can provide haptic feedback on coverage, skin purity or skin health, which is invisible to the human eye. In this embodiment, the haptic feedback may be used to discriminate between treated and non-treated areas. According to another exemplary embodiment, a grooming device can provide haptic feedback on hair density, hair thickness, coverage, style guidance (for example, rendering tactile edges to define the area for treatment), or similar. According to another exemplary embodiment, a hair care device can provide haptic feedback on hair density, thickness, wetness, temperature, coverage, or similar. According to another exemplary embodiment, a tooth care device can provide haptic feedback on remaining plaque, coverage, tongue cleanliness, or similar.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A method for operating a device to render haptic feedback to a user of the device, the device comprising a first part operable to apply a non-invasive action on a part of the body of the user and a second part operable to be held by the user and to render haptic feedback to the user, the method comprising:
acquiring at least one sensor signal indicative of an interaction between the first part of the device and the part of the body of the user, wherein the acquired at least one sensor signal indicative of an interaction between the first part of the device and the part of the body of the user is indicative of one or more of: a surface structure of the part of the body of the user and a property of the part of the body of the user;
processing the acquired at least one sensor signal to determine haptic feedback representative of the interaction between the first part of the device and the part of the body of the user; and
rendering the determined haptic feedback to the user at the second part of the device.

2. A method as claimed in claim 1, wherein the acquired at least one sensor signal indicative of an interaction between the first part of the device and the part of the body of the user is indicative of a speed with which the first part of the device moves on the part of the body of the user.

3. A method as claimed in claim 1, wherein the acquired at least one sensor signal indicative of an interaction between the first part of the device and the part of the body of the user is indicative of a direction in which the first part of the device moves on the part of the body of the user.

4. A method as claimed in claim 1, further comprising:
sensing at least one area of the second part of the device that is held by the user.

5. A method as claimed in claim 4, wherein rendering the determined haptic feedback to the user using the second part of the device comprises:
rendering the determined haptic feedback to the user using at least part of one or more of the sensed at least one areas of the second part of the device held by the user.

6. A method as claimed in claim 4, further comprising:
determining which of the sensed at least one areas of the second part of the device held by the user is the least distance from the first part of the device.

7. A method as claimed in claim 6, wherein rendering the determined haptic feedback to the user using the second part of the device comprises:
rendering the determined haptic feedback to the user using at least part of one or more of the sensed at least one areas of the second part of the device held by the user that is determined to be the least distance from the first part of the device.

8. A method as claimed in claim 1, further comprising one or more of:
modifying the determined haptic feedback over time; and
modifying the determined haptic feedback in accordance with the acquired at least one sensor signal.

9. A method as claimed in claim 1, further comprising:
determining an effect of the interaction between the first part of the device and the part of the body of the user based on the acquired at least one sensor signal; and
wherein processing the acquired at least one sensor signal to determine haptic feedback representative of the interaction between the first part of the device and the part of the body of the user comprises:
processing the acquired at least one sensor signal to determine haptic feedback representative of the determined effect of the interaction between the first part of the device and the part of the body of the user.

10. A computer program product comprising a computer readable medium, the computer readable medium having computer readable code embodied therein, the computer readable code being configured such that, on execution by a suitable computer or processor, the computer or processor is caused to perform the method of claim 1.

11. A device for rendering haptic feedback to a user, the device comprising:
a first part operable to apply a non-invasive action on a part of the body of the user;
a second part operable to be held by the user; and
a control unit configured to:
acquire at least one sensor signal indicative of an interaction between the first part of the device and the part of the body of the user wherein the sensor signal is indicative of one or more of: a surface structure of the part of the body of the user and a property of the part of the body of the user; and
process the acquired at least one sensor signal to determine haptic feedback representative of the interaction between the first part of the device and the part of the body of the user; and
wherein the second part comprises at least one haptic feedback component configured to render the determined haptic feedback to the user.

12. A device as claimed in claim 11, wherein the first part of the device comprises one or more first sensors and the control unit is configured to control the one or more first sensors to acquire the at least one sensor signal.

13. A device as claimed in claim 11, wherein the haptic feedback component comprises one or more of a component configured to:
change temperature;
vibrate;
change a plane of a surface;
change a pressure;
provide electric stimulation;
provide ultrasound;
release air or liquid; and
change texture.

14. A device as claimed in claim 11, wherein the device is a tooth care device, a skin care device, a grooming device, a hair care device, a massage device, or a skin health device.
